(19) United States
(12) Patent Application Publication
(10) Pub. No.: US 2017/0059885 A1
(43) Pub. Date: Mar. 2, 2017

(54) Removably Attachable Corrective Lens

(71) Applicant: Jitendrakumar Patel, Jackson, GA (US)

(72) Inventor: Jitendrakumar Patel, Jackson, GA (US)

(21) Appl. No.: 15/250,077

(22) Filed: Aug. 29, 2016

Related U.S. Application Data
(60) Provisional application No. 62/210,548, filed on Aug. 27, 2015.

(51) Int. Cl. G02C 7/08

(52) U.S. Cl. CPC G02C 7/086

(57) ABSTRACT

A method and device for a removably attachable corrective lens. The removably attachable corrective lens is a corrective lens having an adhesive applied thereon. The removably attachable corrective lens is then secured to an eyeglass lens to provide a new optical prescription for a user. The adhesive is configured to removably attach the corrective lens to an exterior surface of an eyeglass lens. When a user wishes to remove or replace the corrective lens, they may do so by applying an adhesive remover configured to dissolve the adhesive. In some embodiments of the removably attachable corrective lens, the corrective lens is made from a flexible polymer material that is lightweight and scratch resistant.

### CROSS REFERENCE TO RELATED APPLICATIONS

This application claims the benefit of U.S. Provisional Application No. 62/210,548 filed on Aug. 27, 2015. The above identified patent application is herein incorporated by reference in its entirety to provide continuity of disclosure.

### BACKGROUND OF THE INVENTION

The present invention relates to corrective optical lenses. Traditional methods of correcting vision include eyeglasses and contact lenses. Like contact lenses, eyeglass lenses must be custom made to match the unique optical prescription of an individual in order to properly correct their vision, both for near sighted and far sighted individual. The lenses go through a preparatory process of grounding and polishing until the desired optical power is obtained. They are then mounted within a selected frame for use. Because they must be custom made, eyeglass lenses can be costly to manufacture and purchase, especially if a user has specific adjustments required above a basic diopter shift, such as high index of refraction or an astigmatism correction. Many younger eyeglass wearers must replace their lenses every few years as the shape of their eyes, and consequently their required optical prescription, changes. Additionally, older individuals often require optical assistance in focusing on close objects, and require additional reading or bifocal lenses. Purchasing additional eyeglasses can be expensive, as both a new set of lens and a new frame must be purchased. While there currently exits removably attachable lenses that connect to other eyeglasses, they are designed to be temporarily attached and are thus often not secure. Furthermore, they often only offer shaded protection from bright light, similar to non-prescription sunglasses, and fail to provide any optical correction. Accordingly, a method and device for easily adjusting the optical prescription of existing lenses is desired.

### SUMMARY OF THE INVENTION

In view of the foregoing disadvantages inherent in the known types of corrective lenses now present in the prior art, the present invention provides a corrective lens wherein the same can be utilized for providing convenience for the user when wishing to adjust the optical power of the lens in a pair of eyeglasses without fully replacing the existing lenses. The present system comprises a corrective lens having an adhesive applied thereon. The removably attachable corrective lens is then secured to an eyeglass lens to provide a new optical prescription. The adhesive is configured to be removable, such that when a user wishes to remove or replace the corrective lens, they may do so easily. In some embodiments of the removably attachable corrective lens, the corrective lens comprises a flexible polymer material that is lightweight and scratch resistant.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the removably attachable corrective lens with a pair of eyeglasses.

FIG. 2 shows a front perspective view of half and full size embodiments of the removably attachable corrective lens.

FIG. 3 shows a side perspective view of an embodiment of the removably attachable corrective lens.

### DETAILED DESCRIPTION OF THE INVENTION

Reference is made herein to the attached drawings. Like reference numerals are used throughout the drawings to depict like or similar elements of the removably attachable corrective lens. The figures are intended for representative purposes only and should not be considered to be limiting in any respect.

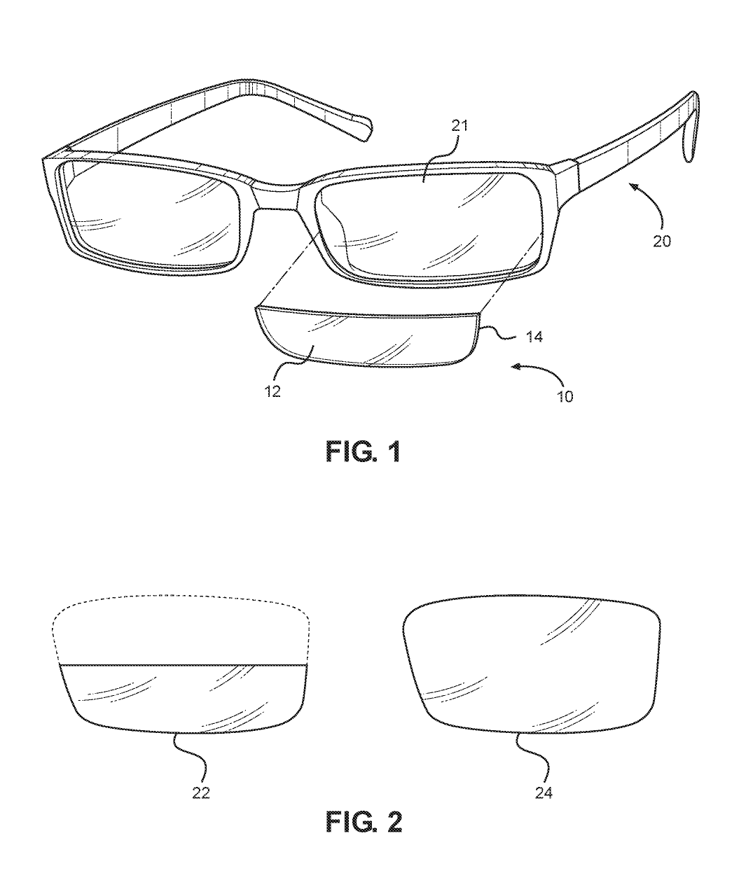

Referring now to FIG. 1, there is shown a perspective view of an embodiment of the removably attachable corrective lens with a pair of eyeglasses. The removably attachable lens 10 comprises a corrective lens 12 having a front side and a rear side. A transparent layer of adhesive 14 is applied to the rear side of the corrective lens 12. The correct lens 12 can be secured to a front side of an eyeglass lens 21 of a pair of eyeglasses 20 by pressing the adhesive 14 thereto. The adhesive 14 is configured such that the effective optical power of the corrective lens 12 is not affected when it is applied thereto, maintaining the optical prescription of the corrective lens 12. In alternative embodiments of the removably attachable lens, the adhesive 14 is applied to the front surface of the corrective lens 12 and placed on a rear surface of an eyeglass lens 21. This allows for a user to secure the corrective lens 12 to a pair of eyeglasses in a less conspicuous manner. Additionally, when the corrective lens 12 is attached to the rear surface of sunglasses, it may be completely hidden from view.

The adhesive is configured to be weakened via an adhesive removing agent, such as a commercial petroleum based degreaser. When a user wishes to change the prescription of their eyeglasses 20, the adhesive 14 is weakened and the corrective lens 21 removed. A user can then secure a new corrective lens with the newly desired optical power to the eyeglass lens, easily producing a new effective prescription.

Referring now to FIG. 2, there is shown a front perspective view of half and full size embodiments of the removably attachable lens. In one embodiment of the removably attachable lens 10, the shape of the corrective lens is configured to cover half 22 of the surface of an eyeglass lens to which it is attached. In an alternative embodiment, the removably attachable lens comprises a full shape 24 configured to cover the entire surface of an eyeglass lens. The various shapes of the removably attachable lens 10 provide a user with the ability to easily add a new index of refraction, and thus a new optical prescription, to an entire lens, or alternatively to only add a new prescription on half the lens, as is common with many bifocal lens that offer different lens prescriptions simultaneously on the same lens.

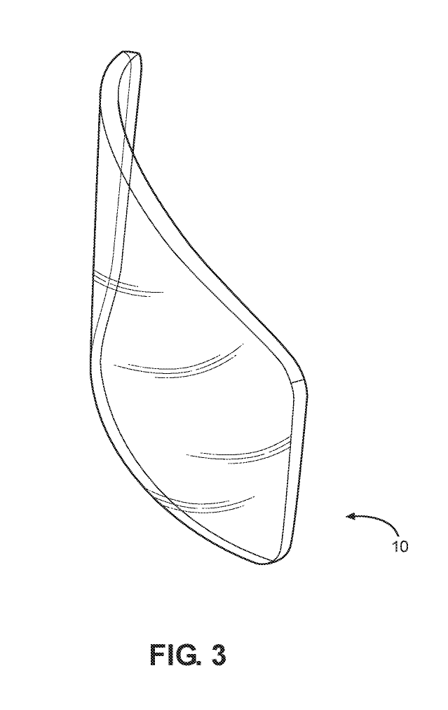

Referring now to FIG. 3, there is shown a side perspective view of the removably attachable corrective lens. The thickness and curvature of the corrective lens 10 controls the effective optical power provided by the lens. The curvature of both the front side 32 and rear side 34 of the corrective lens 12 are integral to the resulting diopter strength. In one embodiment of the removably adjustable lens 10, the correct lens 12 is constructed from a flexible material, such that the front side or rear side can be fully secured to eyeglass lenses of various curvatures. In some embodiments of the removably attachable lens 10, the lens is comprised of a polymer material that is both lightweight and resistant to scratches or cracking.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A removably attachable corrective lens, comprising:
a corrective optical lens comprising a flexible transparent material having a corrective optical power;
an adhesive disposed on the corrective optical lens, wherein the adhesive is transparent;
wherein the removable adhesive is configured to be weakened with an adhesive removal agent.

2) The removably attachable corrective lens of claim 1, wherein the removable adhesive is applied to a front surface of the corrective optical lens.

3) The removably attachable corrective lens of claim 1, wherein the removable adhesive is applied to a rear surface of the corrective optical lens.

4) The removably attachable corrective lens of claim 1, wherein the flexible transparent material comprises a polymer.

5) A method of changing the optical power of an eyeglass lens, comprising:
selecting a removably attachable corrective lens with an optical power, such that the removably attachable corrective lens and the eyeglass lens together produce a desired optical power;
applying a transparent adhesive to a surface of the removably attachable corrective lens;
securing the removably attachable corrective lens onto the eyeglass lens by placing the removably attachable corrective lens such that the transparent adhesive affixes the corrective optical lens to the eyeglass lens.
